(19) United States
(12) Patent Application Publication
(10) Pub. No.: US 2018/0117623 A1
(43) Pub. Date: May 3, 2018

(54) VARIABLE GEOMETRY CAULKING NOZZLE ADAPTOR

(71) Applicant: CRT Tools Inc., Edmonton (CA)

(72) Inventor: Chris Robinson, Stony Plain (CA)

(21) Appl. No.: 15/343,178

(22) Filed: Nov. 3, 2016

(51) Int. Cl. B05C 17/005; B65D 47/06

(52) U.S. Cl. CPC B05C 17/00513; B65D 47/06

(57) ABSTRACT

A caulking tip nozzle adaptor, comprising: a) a main frame portion comprising a main frame body, a main frame tube, a main frame first threaded portion disposed at an outer circumference of the main frame tube and a main frame inner sealing ring at a first end of the main frame tube, wherein a second end of the main frame portion comprises a main frame second threaded portion; b) a friction collar portion comprising a friction collar aperture therethrough and female threads disposed around an inner circumference capable of engaging with the main frame first threaded portion; c) a nozzle portion comprising a nozzle body portion, a nozzle tube and a nozzle sealable ring at a first end of the nozzle portion capable of being sealably and rotatably engaged with the main frame inner sealing ring.

### FIELD OF THE INVENTION

The present disclosure is in the field of caulking gun nozzles and nozzle adaptors.

### BACKGROUND OF THE DISCLOSURE

The use of a caulking gun to dispense material from a conventional caulking cartridge has certain limitations with the application of caulking materials to a crowded space are difficult to access and proper application of the caulking/sealant product is difficult with the standard straight tip.

Today a variety of caulking nozzle adapters on the market that often consist of several parts and may not be suitable for applying the caulking material to surfaces which are difficult to reach. There is a need for a caulking nozzle adapter that is capable of applying caulking material at an angle in tight spaces employing a rotational variable geometry design.

### SUMMARY OF THE INVENTION

Disclosed herein is a caulking tip nozzle adaptor, comprising: a) a main frame portion comprising a main frame body, a main frame tube, a main frame first threaded portion disposed at an outer circumference of the main frame tube and a main frame inner sealing ring at a first end of the main frame tube, wherein a second end of the main frame portion comprises a main frame second threaded portion; b) a friction collar portion comprising a friction collar aperture therethrough and female threads disposed around an inner circumference capable of engaging with the main frame first threaded portion; c) a nozzle portion comprising a nozzle body portion, a nozzle tube and a nozzle sealable ring at a first end of the nozzle portion capable of being sealably and rotatably engaged with the main frame inner sealing ring, and wherein the friction collar is capable of retaining and preventing relative movement of the nozzle portion relative to the main frame body, wherein the main frame tube and the nozzle tube are aligned for the flow of a viscous fluid, and wherein the main frame tube and the nozzle tube each have an interior surface forming a fluid communication pathway extending between a second end of the main frame portion and a second end of the nozzle portion.

### BRIEF DESCRIPTION OF THE DRAWINGS

FIG. 1 is an illustration of an exploded view of a caulking tip nozzle adaptor 100 as disclosed herein.

FIG. 2A is an illustration of an assembled caulking tip nozzle adaptor 200 rotationally positioned at about a 90 degree angle and comprising a nozzle portion 101, friction collar portion 102, main frame portion 103 and base plate adaptor 104.

FIG. 2B is a cross sectional illustration of a caulking tip nozzle adaptor 200 positioned at about a 90 degree angle 203.

FIG. 3A is an illustration of an assembled caulking tip nozzle adaptor 300 rotationally positioned at about a 180 degree angle and comprising a nozzle portion 101, friction collar portion 102, main frame portion 103 and base plate adaptor 104.

FIG. 3B is a cross sectional illustration of a caulking tip nozzle adaptor 200 positioned at about a 180 degree angle 402.

FIG. 4A is a cross sectional illustration of a caulking tip nozzle adaptor 500 whereby the angular flow of caulking material 801 is depicted.

FIG. 4B is an illustration of an assembled caulking tip nozzle adaptor 500 rotationally positioned at about a 120 degree angle 501.

FIG. 5 is a side view illustration of the base plate adaptor 104.

FIG. 6 is a cross sectional illustration of the base plate adaptor 104 comprising a base plate adaptor body 1114.

FIG. 7 is a top view illustration of the main frame portion 103 comprising a main frame inner sealing ring 1202.

FIG. 8 is a cross sectional illustration of the main frame portion 103 comprising a main frame inner sealing ring 1202 and a main frame sealing ring groove 1319.

FIG. 9 is a side view illustration of the main frame portion 103 showing a main frame portion height 1302 and a main frame first threaded 1203.

FIG. 10 is a bottom view of a large nozzle 1700 comprising a lip 1702 of a base 1704 of the large nozzle 1700.

FIG. 11 is a top and side view illustration of a nozzle portion 101 comprising a nozzle portion sealable ring 1403, an outer threaded portion 1404, and a nozzle tube 1401.

FIG. 12 is a top and side view illustration of a nozzle portion 101 comprising a nozzle portion sealable ring 1403, an outer threaded portion 1404, and a nozzle tube 1401.

FIG. 13 is a bottom view illustration of a nozzle portion 101 or a base plate adaptor 104 comprising a base plate adaptor sealable ring outer diameter 1112 and a bottom view of a nozzle portion base outer diameter 1412, and a base ring inner diameter 1105 and a nozzle portion base inner diameter 1413.

FIG. 14 is a top and side view illustration of a nozzle portion 800 as disclosed herein further comprising a nozzle cone 1418.

FIG. 15 is a top view illustration of a friction collar portion 102.

FIG. 16 is a cross sectional view illustration of a friction collar portion 102.

FIG. 17A is an exploded view 700 of 2 inch diameter sausage and/or cartridge barrel 1602 engaged with caulking tip nozzle adaptor 1603.

FIG. 17B is an exploded view 800 of 2 inch diameter sausage and/or cartridge barrel 1602 engaged with caulking tip nozzle adaptor 1604.

FIG. 17C is an exploded view 1000 of 2 inch diameter sausage and/or cartridge barrel 1602 engaged with caulking tip nozzle adaptor 1605.

### DETAILED DESCRIPTION OF THE EMBODIMENTS

The following is a detailed description of certain specific embodiments of caulking tip nozzle adaptors as disclosed herein.

In one aspect, disclosed herein is a caulking tip nozzle adaptor, comprising: a) a main frame portion comprising a main frame body, a main frame tube, a main frame first threaded portion disposed at an outer circumference of the main frame tube and a main frame inner sealing ring at a first end of the main frame tube, wherein a second end of the main frame portion comprises a main frame second threaded portion; b) a friction collar portion comprising a friction collar aperture therethrough and female threads disposed around an inner circumference capable of engaging with the main frame first threaded portion; c) a nozzle portion comprising a nozzle body portion, a nozzle tube and a nozzle sealable ring at a first end of the nozzle portion capable of being sealably and rotatably engaged with the main frame inner sealing ring, and wherein the friction collar is capable of retaining and preventing relative movement of the nozzle portion relative to the main frame body, wherein the main frame tube and the nozzle tube are aligned for the flow of a viscous fluid, wherein the main frame tube and the nozzle tube each have an interior surface forming a fluid communication pathway extending between a second end of the main frame portion and a second end of the nozzle portion, and wherein the main frame first threaded portion is at an angle relative to a short body portion of the main frame body.

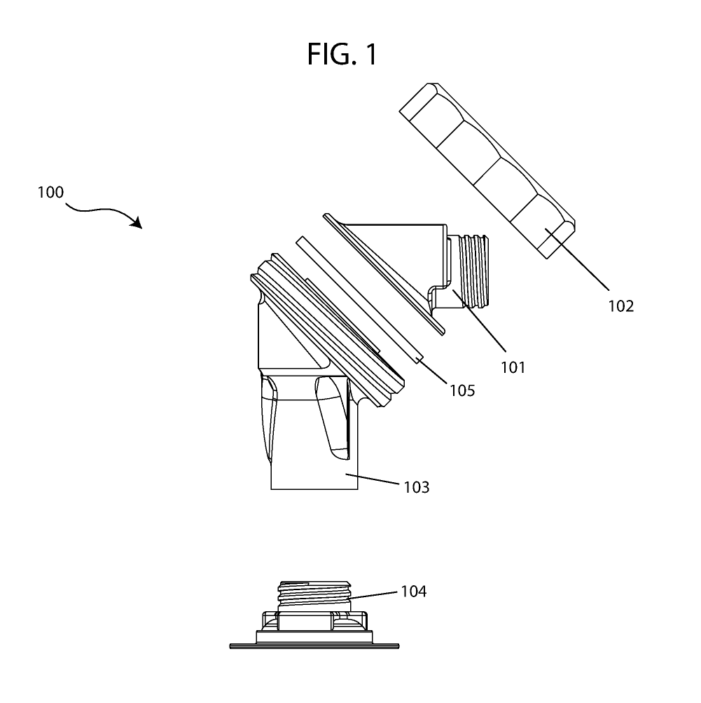

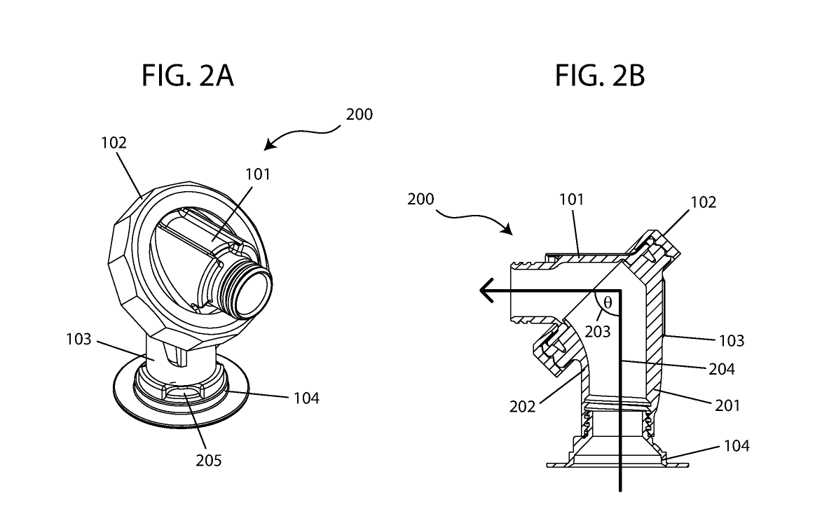

Turning to the drawings, FIG. 1 depicts an exploded view of a tubular caulking tip nozzle adaptor 100 comprising a main frame body 103, friction collar portion 102, an elastomeric O-ring or gasket 105, nozzle portion 101 and a base plate adaptor 104. As shown, the nozzle portion 102 and the main frame body 103 are rotatably engaged at an angle. FIG. 2A depicts an assembled caulking tip nozzle adaptor 200 rotationally positioned at about a 90 degree angle and comprising a nozzle portion 101, friction collar portion 102, main frame portion 103 and base plate adaptor 104. Moreover, the base plate adaptor 104 comprises plurality of base plate notches 205. FIG. 2B depicts a cross sectional illustration of a caulking tip nozzle adaptor 200 positioned at about a 90 degree angle 203. In this orientation, the flow of caulking material 204 follows the route provided by the inner surface of the caulking tip nozzle adaptor 100 with the caulking tip nozzle adaptor 200 positioned at about a 90 degree angle 203. The caulking tip nozzle adaptor disclosed herein may be adjusted to change the angle of the adaptor for applying caulking material in tight spaces by loosening the friction collar portion 102, rotating the nozzle portion 101 and retightening the friction collar portion 102. The main frame body 103 comprises short body portion 202 and a long body portion 201. In some embodiments, the nozzle portion comprises a nozzle tube at a second end of the nozzle with angle of about 45 degrees relative to the nozzle sealable ring, and wherein the nozzle portion may be rotated to provide a caulking tip nozzle adaptor angle in a range between about 90 degrees and 180 degrees relative to the main frame portion.

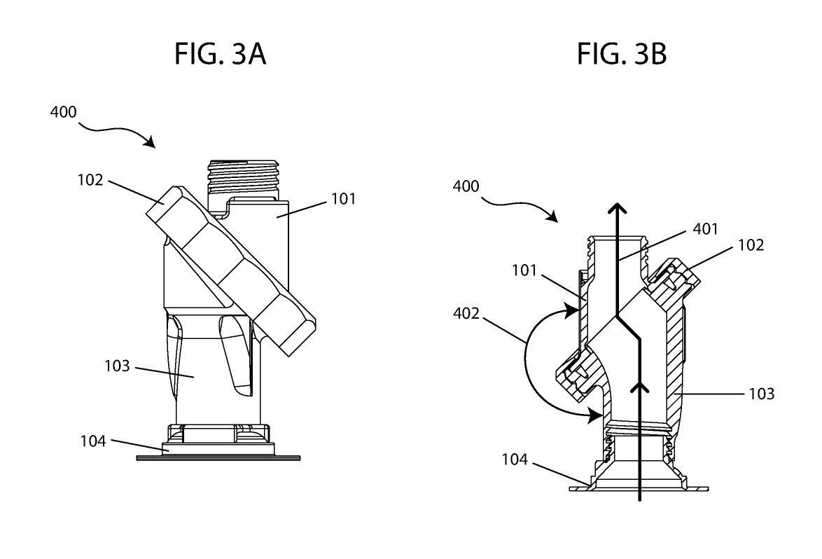

In this aspect, FIG. 3A depicts an assembled caulking tip nozzle adaptor 300 rotationally positioned at about a 180 degree angle and comprising a nozzle portion 101, friction collar portion 102, main frame portion 103 and base plate adaptor 104. FIG. 3B is a cross sectional illustration of a caulking tip nozzle adaptor 200 positioned at about a 180 degree angle 402. In this orientation, the flow of caulking material 401 follows the route provided by the inner surface of the caulking tip nozzle adaptor 400 with the caulking tip nozzle adaptor 400 positioned at about a 90 degree angle 402.

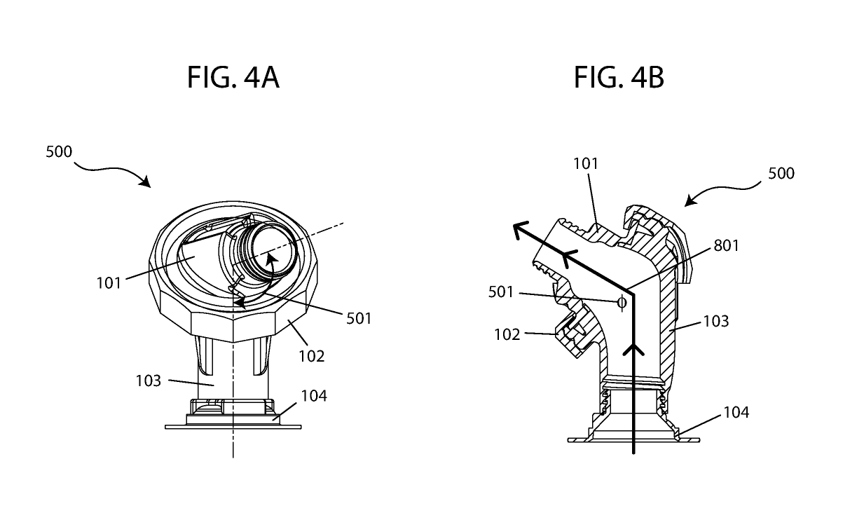

The caulking tip nozzle adaptor disclosed herein may be adjusted to change the angle between about 90 degrees and 180 degrees by loosening the friction collar portion 102, rotating the nozzle portion 101 and retightening the friction collar portion 102. The main frame body 103 comprises short body portion 202 and a long body portion 201. Turning to FIG. 4A, the illustration depicts an assembled caulking tip nozzle adaptor 500 rotationally positioned at about a 120 degree angle 501. FIG. 4B is a cross sectional illustration of a caulking tip nozzle adaptor 500 whereby the angular flow of caulking material 801 is depicted. In this orientation, the flow of caulking material 801 followings the route provided by the inner surface of the caulking tip nozzle adaptor 500 with the caulking tip nozzle adaptor 500 positioned at about a 120 degree angle 501.

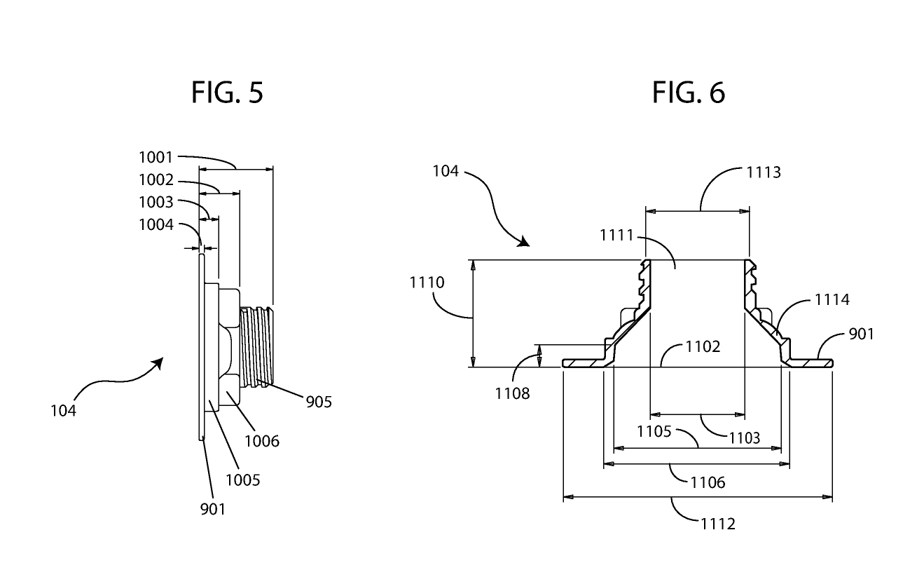

The caulking tip nozzle adaptor disclosed herein comprises a base plate adaptor 104. In some embodiments, the caulking tip nozzle adaptor further comprises a base plate adaptor. In some embodiments, the caulking tip nozzle adaptor further comprises a base plate adaptor, wherein a base ring of the base plate adaptor is capable of engaging with a 2 inch diameter sausage and/or cartridge barrel dispensing applicator gun and an applicator gun front cap. In some embodiments, the caulking tip nozzle adaptor further comprises a base plate adaptor, wherein the base plate adaptor comprises a threaded portion capable of engaging with the second threaded portion of the main frame portion. In some embodiments, the caulking tip nozzle adaptor further comprises a base plate adaptor, wherein the base plate adaptor comprises a male thread portion capable of engaging with the female threaded portion of the main frame portion, and wherein a base ring of the base plate adaptor is capable of engaging with a 2 inch diameter sausage and/or cartridge barrel dispensing applicator gun and the applicator gun's front cap. As illustrated, FIG. 5 depicts a side view illustration of the base plate adaptor 104 comprising a base plate adaptor sealing ring 901, first base plate adaptor segment 1005, second base plate adaptor segment 1006 and a male thread portion 905. In some embodiments, the male thread portion 905 comprises a buttress thread with an outer diameter 1113 of between about 0.25 inches and 1.5 inches and a pitch of between about 0.05 inches and 0.5 inches. In some embodiments, the male thread portion 905 comprises a buttress thread with an outer diameter 1113 of about 0.963 inches and a pitch of about 0.125 inches. Furthermore, the base plate adaptor 104 comprises a base ring height 1004, first base plate adaptor segment height 1003, first base plate adaptor segment height 1002 and a male thread portion height 1001. In some embodiments, the base ring height 1004 is between about 0.02 inches and 0.1 inches. In some embodiments, the base ring height 1004 is about 0.06 inches. FIG. 6 depicts a cross sectional illustration of the base plate adaptor 104. In this view, the base plate adaptor 104 comprises a base plate tube outlet 1111 and a base plate tube inlet 1102 with a thread diameter 1113, a base sealing ring outer diameter 1112, a base sealing ring inner diameter 1105, base ring inner diameter height 1108, a first base plate adaptor segment outer diameter 1106, a base plate adaptor overall height 1110, a base plate adaptor inner tube diameter 1103. In some embodiments, the base plate adaptor inner tube diameter 1103 is between about 0.25 inches and 1.5 inches. In some embodiments, the base plate adaptor inner tube diameter 1103 is about 0.79 inches. In some embodiments, the base ring inner diameter 1105 is between about 0.75 inches and 1.75 inches. In some embodiments, the base ring inner diameter 1105 is about 0.79 inches. In some embodiments, the first base plate adaptor segment outer diameter 1106 is between about 1.0 inch and 1.75 inches. In some embodiments, the first base plate adaptor segment outer diameter 1106 is about 1.56 inches. In some embodiments, the base ring inner diameter height 1108 is between about 0.05 inches and 0.75 inches. In some embodiments, the base ring inner diameter height 1108 is about 0.19 inches. In some embodiments, the base sealing ring outer diameter 1112 is between about 2.0 inches and 2.5 inches. In some embodiments, the base sealing ring outer diameter 1112 is about 2.24 inches.

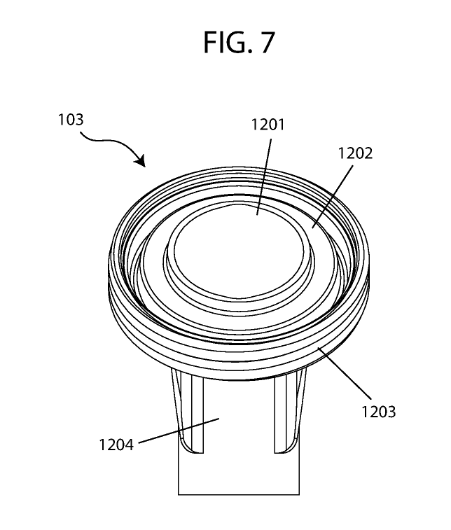

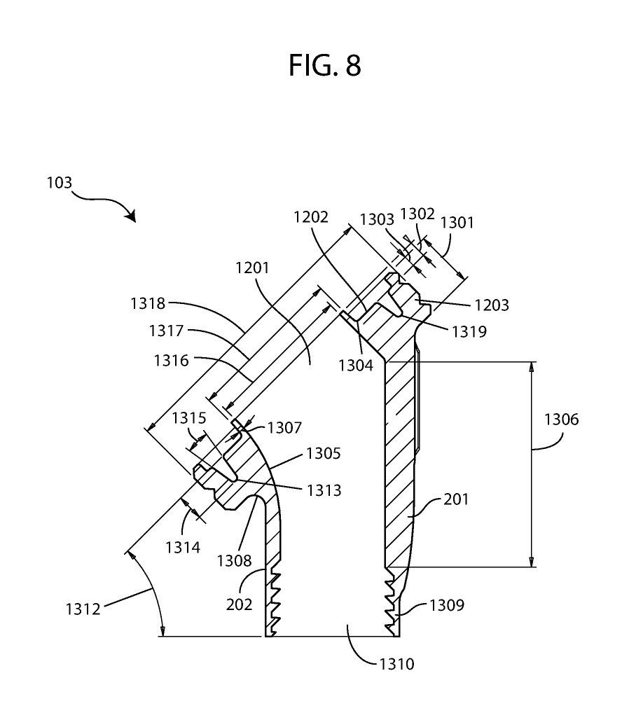

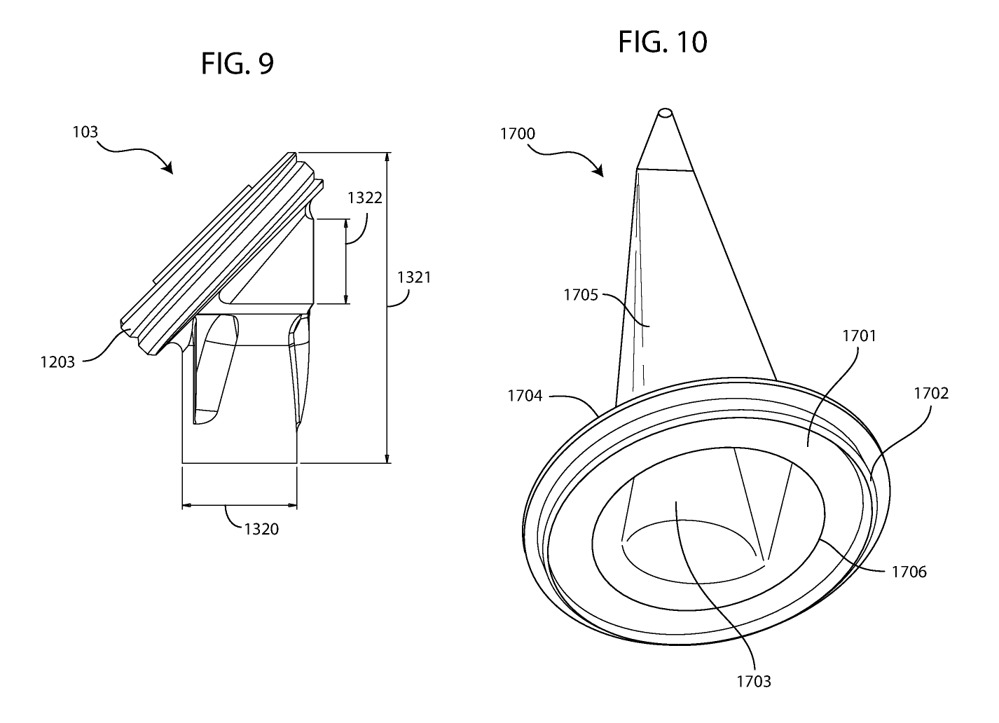

Turning to the drawings, FIG. 7 depicts the main frame portion 103 comprising a main frame inner sealing ring 1202, tube inlet 1310, main frame first threaded portion 1203 disposed at an outer circumference of the main frame tube 1201 molded with the main frame body 1204. In some embodiments, the main frame first threaded portion is at an angle relative to a tube inlet 1310 of the main frame body. In some embodiments, the main frame first threaded portion is at an angle of between about 30 degrees and 60 degrees relative to a tube inlet 1310 of the main frame body. In some embodiments, the outer threaded circumference is molded at an angle relative to a tube inlet 1310 of about 45 degrees. FIG. 8 is a cross sectional illustration of the main frame portion 103 comprising a main frame inner sealing ring 1202 and a main frame sealing ring groove 1313. In some embodiments, the main frame inner sealing ring is at an angle of between about 30 degrees and 60 degrees relative to a tube inlet 1310 of the main frame body. The main frame sealing ring groove 1313 has an angle of opening 1315. The main frame portion 103 comprises a main frame first threaded portion 1203 height 1301, diameter 1318, an outer diameter 1317, an inner diameter 1316, a height 1302 and a height 1303 between the top of the main frame first threaded portion 1203 and the top of an inner lip portion 1307. In some embodiments, the main frame portion 103 comprises a main frame first threaded portion 1203 height 1301 between about 0.25 inches and 1.0 inch, a diameter 1318 between about 2.0 inches and 4 inches, an outer diameter 1317 between about 0.5 inches and 2 inches, an inner diameter 1316 between about 0.5 inches and 1.5 inches, a height 1302 between about 0.1 inches and 0.75 inches, and a height 1303 between the top of the main frame first threaded portion 1203 and the top of an inner lip portion 1307 of between about 0.05 inches and 0.5 inches. In some embodiments, the main frame portion 103 comprises a main frame first threaded portion 1203 height 1301 of about 0.5 inches, a diameter 1318 of about 2.48 inches, an outer diameter 1317 of about 1.36 inches, an inner diameter 1316 of about 1.27 inches, a height 1302 of about 0.15 inches, and a height 1303 between the top of the main frame first threaded portion 1203 and the top of an inner lip portion 1307 of about 0.1 inch. Furthermore, the main frame inner sealing ring 1202 and/or the main frame tube 1201 are formed at an angle 1312 relative to the tube inlet 1310 between about 30 degrees and 60 degrees. Moreover, the main frame first threaded portion 1203 and/or the main frame tube 1201 are formed at an angle 1312 relative to the tube inlet 1310 between about 30 degrees and 60 degrees. In some embodiments, the main frame first threaded portion is at an angle of between about 30 degrees and 60 degrees relative to a tube inlet portion of the main frame body. In some embodiments, the main frame inner sealing ring is at an angle of between about 30 degrees and 60 degrees relative to a tube inlet portion of the main frame body. In some embodiments, the angle 1312 is about 45 degrees. The inner lip portion 1307 and the main frame inner sealing ring 1202 intersect at a radius 1304 of about 0.03 inches. In some embodiments, the inner lip portion 1307 and the main frame inner sealing ring 1202 intersect at a radius 1304 of between about 0.01 inches and 0.1 inches. In some embodiments, the main frame inner sealing ring of the main frame portion comprises an inner lip portion capable of engaging with an inner diameter of the first end of the nozzle tube. Moreover, the angled tubular main frame portion 103 comprises a radius 1305 of about 1.25 inches of a circumference of the short body portion 202. In some embodiments, the angled tubular main frame portion 103 comprises a radius 1305 of between about 0.75 inches and 1.75 inches. In some embodiments, the main frame second threaded portion is disposed on an inner circumference of the second end of the main frame portion. As illustrated, the main frame portion 103 has a height 1306 from the second threaded portion 1309 of the second end 1310. In some embodiments, the second threaded portion 1309 is capable of engaging a buttress thread with an outer diameter between about 0.25 inches and 1.5 inches and a pitch of between about 0.05 inches and 0.5 inches. In some embodiments, the second threaded portion 1309 is capable of engaging a buttress thread with an outer diameter of about 0.963 inches and a pitch of about 0.125 inches. The short body portion 202 has an outer radius 1308 of about 0.1 inches, an inner radius 1305 of about 1.25 inches. In some embodiments, the short body portion 202 has an outer radius 1308 of between about 0.05 inches and 0.9 inches, an inner radius 1305 of between about 0.75 inches and 1.75 inches. The main frame portion 103 has a height 1314 between the bottom of the main frame sealing ring groove 1313 and the main frame inner sealing ring 1202. FIG. 9 is a side view illustration of the main frame portion 103 showing a main frame portion height 1321, main frame first threaded portion 1203, main frame tube height 1322 and a main frame tube diameter 1320. In some embodiments, the main frame portion height 1321 is between about 2.5 inches and 8 inches, main frame tube height 1322 between about 0.5 inches and 1.0 inches, and a main frame tube diameter 1320 between about 0.75 inches and 1.15 inches. In some embodiments, the main frame portion height 1321 is about 3.12 inches, main frame tube height 1322 is about 0.85 inches, and the main frame tube diameter 1320 is about 1.15 inches. FIG. 10 is a bottom view of a large angled nozzle 1700 comprising a lip 1702 of a base 1704, a large nozzle sealing ring 1701, a large nozzle sealing ring inner diameter 1706, tube opening 1703, and tube 1705. The large nozzle sealing ring 1701 is capable of being sealably engaged with the main frame inner sealing ring 1202 with or without the elastomeric O-ring or gasket 105. Moreover, the lip 1702 of a base 1704 is capable of being sealably engaged with the main frame sealing ring groove 1313. In some embodiments, the main frame inner sealing ring further comprises a main frame sealing ring groove positioned adjacent to an outer diameter of the main frame inner sealing ring having a diameter and depth capable of engaging with a lip of a base of a large nozzle. In some embodiments, the main frame inner sealing ring further comprises an elastomeric O-ring or gasket disposed on the main frame inner sealing ring. In some embodiments, the main frame inner sealing ring further comprises an elastomeric O-ring or gasket disposed on the main frame inner sealing ring, wherein the elastomeric O-ring or gasket is capable of forming a seal with the main frame inner sealing ring and the nozzle sealable ring with the friction collar portion tightened via the main frame first threaded portion.

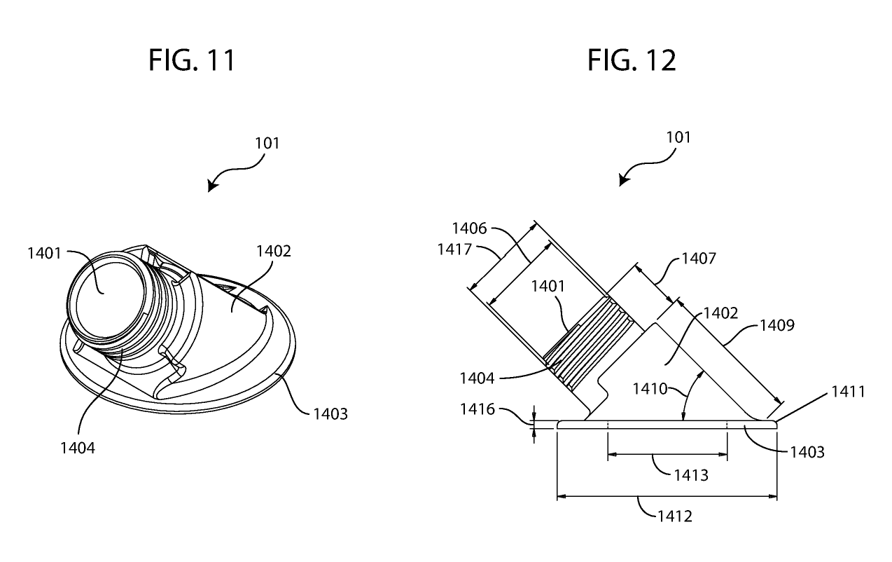

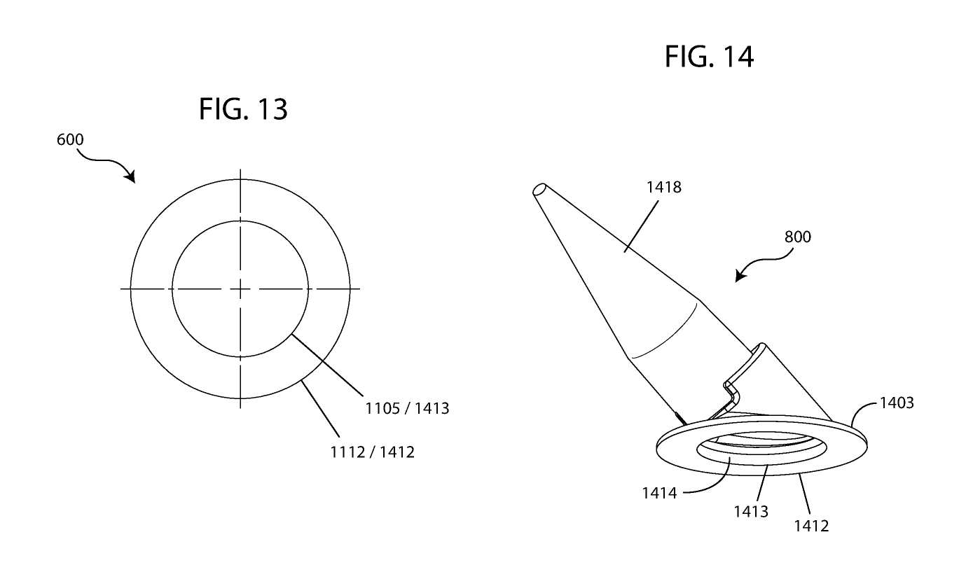

Turning to FIG. 11, the nozzle portion 101 comprises a nozzle portion sealable ring 1403, a nozzle portion body 1402, an outer threaded portion 1404, and a nozzle tube 1401. The nozzle portion sealable ring 1403 at a first end of the nozzle portion 101 is capable of being sealably engaged with the main frame inner sealing ring 1202 with or without the elastomeric O-ring or gasket 105. Moreover, the inner lip portion 1307 of the main frame portion 103 is capable of being sealably engaged with an inner diameter 1413 of the nozzle portion sealable ring 1403 of the nozzle portion 101. In some embodiments, the male thread portion 1404 comprises a buttress thread with an outer diameter 1417 between about 0.25 inches and 1.5 inches and a pitch of between about 0.05 inches and 0.5 inches. In some embodiments, the male thread portion 1404 comprises a buttress thread with an outer diameter 1417 of about 0.963 inches and a pitch of about 0.125 inches. Moreover, FIG. 12 depicts a nozzle tube 1401 having a diameter 1406, nozzle portion sealable ring 1403 with an outer diameter 1412, an inner diameter 1413, a nozzle tube 1401 with a top length 1409, wherein the nozzle tube 1401 has an angle 1410 relative to an upper circumference of the nozzle tube 1401 and the nozzle portion sealable ring 1403, and wherein the nozzle portion sealable ring 1403 has a thickness 1416 and a radius 1411 of about 0.02 inches. In some embodiments, the nozzle portion sealable ring 1403 has a thickness 1416 and a radius 1411 of between about 0.05 inches and 0.1 inches. In some embodiments, the nozzle tube 1401 has an inner diameter 1406 between about 0.5 inches and 1.0 inch, nozzle portion sealable ring 1403 with a diameter 1412 between about 1.5 inches and 3.5 inches, a nozzle tube 1401 with a top length 1409 between about 1.0 inch and 8 inches, wherein the nozzle tube 1401 has an angle 1410 between about 10 degrees and 60 degrees relative to an upper circumference of the nozzle tube 1401 and the nozzle portion sealable ring 1403, and wherein the nozzle portion sealable ring 1403 has a thickness 1416 between about 0.05 inches and 0.25 inches. In some embodiments, the nozzle tube 1401 has an inner diameter 1406 of about 0.79 inch, nozzle portion sealable ring 1403 with a outer diameter 1412 of about 2.24 inches, a nozzle tube 1401 with a first top length 1409 of about 1.5 inches and a second top length 1407 of about 0.55 inches, wherein the nozzle tube 1401 has an angle 1410 of about 45 degrees relative to an upper circumference of the nozzle tube 1401 and the nozzle portion sealable ring 1403, and wherein the nozzle portion sealable ring 1403 has a thickness 1416 of about 0.08 inches. In some embodiments, the first top length 1409 is between about 1.0 inches and 6 inches and a second top length 1407 between about 0.25 inches and 6 inches. In some embodiments, the nozzle portion comprises a nozzle tube at a second end of the nozzle with angle of between about 30 degrees and 60 degrees relative to the nozzle sealable ring, and wherein the second end of the nozzle portion comprises an outer threaded portion capable of engaging with an inner threaded portion of a small nozzle. In some embodiments, the nozzle portion comprises a nozzle tube at a second end of the nozzle with angle of about 45 degrees relative to the nozzle sealable ring. FIG. 13 depicts a bottom view of a base plate adaptor sealable ring outer diameter 1112 and a bottom view of a nozzle portion base outer diameter 1412. Also shown are the base ring inner diameter 1105 and a nozzle portion base inner diameter 1413. The bottom view of the nozzle portion sealable ring 1403 comprises the nozzle portion base outer diameter 1412 and the nozzle portion base inner diameter 1413 which forms a fluid communication pathway with nozzle tube inlet 1414 and nozzle tube 1401 of FIG. 12. In some embodiments, the base plate adaptor sealable ring outer diameter 1112 and the nozzle portion base outer diameter 1412 are each independently between about 2.0 inches and 2.5 inches, the base ring inner diameter 1105 and the nozzle portion base inner diameter 1413 are each independently between about 0.75 inches and 1.75 inches. In some embodiments, the base plate adaptor sealable ring outer diameter 1112 and the nozzle portion base outer diameter 1412 are each about 2.24 inches, and the base ring inner diameter 1105 and the nozzle portion base inner diameter 1413 are each about 1.39 inches. In some embodiments, a nozzle portion 800 may comprises a nozzle cone 1418 molded with the body of the nozzle portion 101, as depicted with FIG. 14.

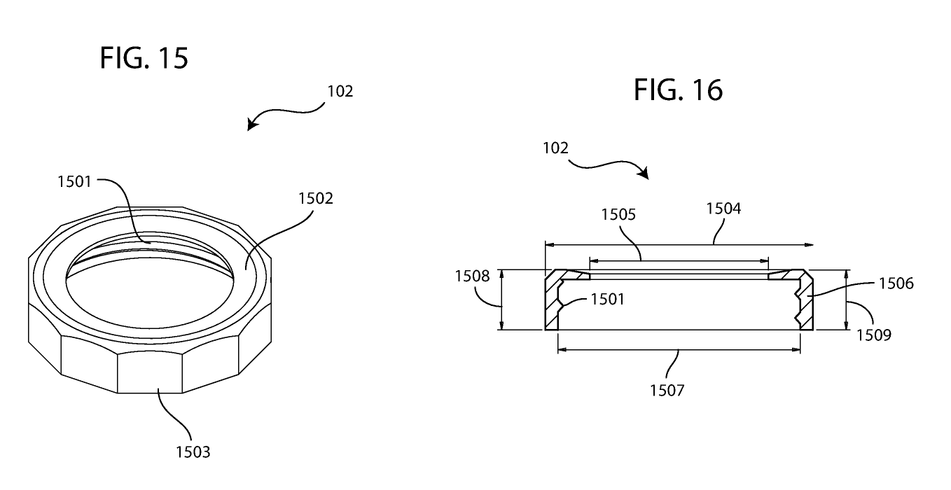

Turning to drawings, FIG. 15 is a top view illustration of a friction collar portion 102. FIG. 16 is a cross sectional view illustration of a friction collar portion 102. As depicted, the friction collar portion 102 comprises female threads 1501 disposed around an inner circumference capable of engaging with the main frame first threaded portion. Moreover, the friction collar portion 102 comprises a top face 1502 capable of engaging with a base 1704 of a large nozzle 1700 or a nozzle portion sealable ring 1403 as presented with FIGS. 10 and 11, respectively. The friction collar portion 102 comprises a body 1506 with a height 1508, an inner diameter 1507, an outer width 1504, a top face diameter 1505. In some embodiments, the friction collar portion 102 comprises a body 1506 with an outer height 1508 between about 0.25 inches and 1.0 inch, an inner height 1509 between about 0.25 inches and 0.9 inches, an inner diameter 1507 between about 1.5 inches and 3.5 inches, an outer width 1504 between about 2.0 inches and 3.5 inches, a top face diameter 1505 between about 1.25 inches and 2.25 inches. In some embodiments, the friction collar portion 102 comprises a body 1506 with an outer height 1508 of about 0.63 inches, an inner height 1509 of about 0.53 inches, an inner diameter 1507 of about 2.51 inches, an outer width 1504 of about 2.77 inches, a top face diameter 1505 of about 1.85 inches. In some embodiments, the friction collar portion 102 comprises a plurality of ridges 1503.

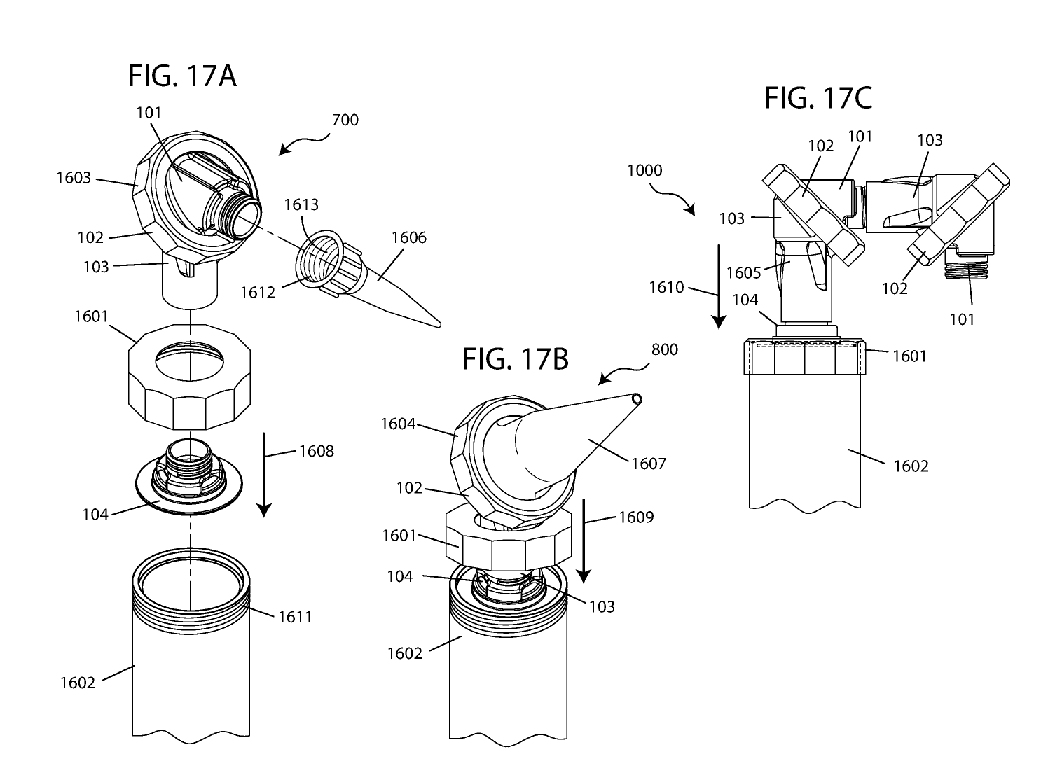

Turning to FIGS. 17A, 17B and 17C, the exploded view 700, view 800, and view 1000 each depict a 2.0 inch diameter sausage and/or cartridge barrel 1602 comprising threads 1611 engaged 1608 with caulking tip nozzle adaptor 1603, engaged 1609 with caulking tip nozzle adaptor 1604, or engaged 1610 with caulking tip nozzle adaptor 1605. The caulking tip nozzle adaptor 1603 comprises a small nozzle 1606 capable of being engaged with the threaded portion 1404 (FIG. 11) of the nozzle 101 via threads 1613 of the tube 1612. In some aspects, the caulking tip nozzle adaptor 1604 comprises a large straight nozzle 1607 engaged with the main frame portion 103 via the main frame inner sealing ring 1202 and the large nozzle sealing ring 1701 (FIG. 10), the friction collar portion 102, and with or without the O-ring or gasket 105. In some embodiments, the nozzle portion comprises a nozzle tube at a second end of the nozzle with angle of about 45 degrees relative to the nozzle sealable ring, wherein the second end of the nozzle portion comprises an outer threaded portion capable of engaging with the inner threaded portion of a small nozzle, and wherein the small nozzle may be a straight nozzle, an angled nozzle or an adjustable nozzle. In some embodiments, the nozzle portion comprises a straight nozzle, an angled nozzle or an adjustable nozzle at a second end of the nozzle. The sausage and/or cartridge barrel 1602 is also capable of being engaged 1610 with caulking tip nozzle adaptor 1605. In some aspect, the sausage and/or cartridge barrel 1602 is capable of being engaged 1610 with caulking tip nozzle adaptor 1605. In some embodiments, the caulking tip nozzle adaptor further comprises that the nozzle portion is engaged with a main frame second threaded portion of a caulking tip nozzle adaptor disclosed herein connected in series. In each configuration, the sausage and/or cartridge barrel cap 1601 is capable of engaging with the base plate adaptor 104. In some embodiments, the nozzle portion 1607 is a commercially available large caulking nozzle, wherein the large nozzle may be a straight nozzle, an angled nozzle or an adjustable nozzle capable of being sealably engaged with the main frame inner sealing ring 1202 and the friction collar portion 102 with or without the elastomeric O-ring or gasket 105 as disclosed herein. In some embodiments, the nozzle portion is a commercially available small caulking nozzle, wherein the small nozzle may be a straight nozzle, an angled nozzle or an adjustable nozzle capable of being engaged with the threaded portion 1404 (FIG. 11) of the nozzle 101 as disclosed herein.

In some embodiments, the caulking tip nozzle adaptor is constructed from plastic, rubber, steel, aluminum, copper, stainless steel, aluminum alloy, tin, polyethylene, polyethylene (HDPE) and/or polypropylene. Additional examples may include low density polyethylene (LDPE), linear low density polyethylene (LLDPE), polybutylene and copolymers of ethylene such as polyethylene-vinyl acetate (EVA), polyethylene-acrylic acid (EAA), polyethylene-methacrylic acid EMA) or copolymers of ethylene or propylene with the lower olefins such as, butene-1, pentene-1, hexene or octane, or a combination thereof.

The caulking tip nozzle adaptor as disclosed provides for low flow and low viscous application of caulking material and other suitable viscous materials. Other features include no flow restrictor and the nozzle portion may be threaded to interchange different types of nozzles available in the market with the standard outer thread of the nozzle portion as disclosed herein. Moreover, the base plate is removable to allow installation onto standard caulking applicators and sausage and/or cartridge barrels. With O-ring or gasket the caulking material remains in the tube and allows for convenient and simple rotation of nozzle portion.

### Definitions

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that can vary depending upon the desired properties sought to be obtained. It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. As used herein, the term “comprising” means including elements or steps that are identified following that term, but any such elements or steps are not exhaustive, and an embodiment can include other elements or steps.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and devices within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or devices, which can of course vary. It is also to be understood that the terminology used herein is for the purpose of describing particular embodiments only, and is not intended to be limiting.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict any definitions in this disclosure.

What is claimed is:

1. A caulking tip nozzle adaptor, comprising:
a) a main frame portion comprising a main frame body, a main frame tube, a main frame first threaded portion disposed at an outer circumference of the main frame tube and a main frame inner sealing ring at a first end of the main frame tube, wherein a second end of the main frame portion comprises a main frame second threaded portion;
b) a friction collar portion comprising a friction collar aperture therethrough and female threads disposed around an inner circumference capable of engaging with the main frame first threaded portion;
c) a nozzle portion comprising a nozzle body portion, a nozzle tube and a nozzle sealable ring at a first end of the nozzle portion capable of being sealably and rotatably engaged with the main frame inner sealing ring, and wherein the friction collar is capable of retaining and preventing relative movement of the nozzle portion relative to the main frame body,
wherein the main frame tube and the nozzle tube are aligned for the flow of a viscous fluid, and wherein the main frame tube and the nozzle tube each have an interior surface forming a fluid communication pathway extending between a second end of the main frame portion and a second end of the nozzle portion.

2. The caulking tip nozzle adaptor of claim 1, wherein the main frame first threaded portion is at an angle of between about 30 degrees and 60 degrees relative to a tube inlet portion of the main frame body.

3. The caulking tip nozzle adaptor of claim 1, wherein the main frame inner sealing ring is at an angle of between about 30 degrees and 60 degrees relative to a tube inlet portion of the main frame body.

4. The caulking tip nozzle adaptor of claim 1, wherein the main frame first threaded portion is molded at an angle of about 45 degrees relative to a tube inlet portion of the main frame body.

5. The caulking tip nozzle adaptor of claim 1, wherein the main frame second threaded portion is disposed on an inner circumference of the second end of the main frame portion.

6. The caulking tip nozzle adaptor of claim 1, wherein the main frame inner sealing ring of the main frame portion comprises an inner lip portion capable of engaging with an inner diameter of the first end of the nozzle tube.

7. The caulking tip nozzle adaptor of claim 1, wherein the main frame inner sealing ring further comprises a main frame sealing ring groove positioned adjacent to an outer diameter of the main frame inner sealing ring having a diameter and depth capable of engaging with a lip of a base of a large nozzle.

8. The caulking tip nozzle adaptor of claim 1, wherein the main frame inner sealing ring further comprises an elastomeric O-ring or gasket disposed on the main frame inner sealing ring.

9. The caulking tip nozzle adaptor of claim 1, wherein the main frame inner sealing ring further comprises an elastomeric O-ring or gasket disposed on the main frame inner sealing ring, wherein the elastomeric O-ring or gasket is capable of forming a seal with the main frame inner sealing ring and the nozzle sealable ring with the friction collar portion tightened via the main frame first threaded portion.

10. The caulking tip nozzle adaptor of claim 1, wherein the nozzle portion is a large nozzle, wherein the large nozzle may be a straight nozzle, an angled nozzle or an adjustable nozzle.

11. The caulking tip nozzle adaptor of claim 1, wherein the nozzle portion comprises a nozzle tube at a second end of the nozzle with angle of between about 30 degrees and 60 degrees relative to the nozzle sealable ring, and wherein the second end of the nozzle portion comprises an outer threaded portion capable of engaging with an inner threaded portion of a small nozzle.

12. The caulking tip nozzle adaptor of claim 1, wherein the nozzle portion comprises a nozzle tube at a second end of the nozzle with angle of about 45 degrees relative to the nozzle sealable ring.

13. The caulking tip nozzle adaptor of claim 1, wherein the nozzle portion comprises a nozzle tube at a second end of the nozzle with angle of about 45 degrees relative to the nozzle sealable ring, wherein the second end of the nozzle portion comprises an outer threaded portion capable of engaging with the inner threaded portion of a small nozzle, and wherein the small nozzle may be a straight nozzle, an angled nozzle or an adjustable nozzle.

14. The caulking tip nozzle adaptor of claim 1, wherein the nozzle portion comprises a straight nozzle, an angled nozzle or an adjustable nozzle at a second end of the nozzle.

15. The caulking tip nozzle adaptor of claim 1, further comprising the nozzle portion is engaged with a main frame second threaded portion of a caulking tip nozzle adaptor of claim 1 connected in series.

16. The caulking tip nozzle adaptor of claim 1, wherein the nozzle portion comprises a nozzle tube at a second end of the nozzle with angle of about 45 degrees relative to the nozzle sealable ring, and wherein the nozzle portion may be rotated to provide a caulking tip nozzle adaptor angle in a range between about 90 degrees and 180 degrees relative to the main frame portion.

17. The caulking tip nozzle adaptor of claim 1, further comprising a base plate adaptor.

18. The caulking tip nozzle adaptor of claim 1, further comprising a base plate adaptor, wherein a base ring of the base plate adaptor is capable of engaging with a 2 inch diameter sausage and/or cartridge barrel dispensing applicator gun and an applicator gun front cap.

19. The caulking tip nozzle adaptor of claim 1, further comprising a base plate adaptor, wherein the base plate adaptor comprises a threaded portion capable of engaging with the second threaded portion of the main frame portion.

20. The caulking tip nozzle adaptor of claim 1, further comprising a base plate adaptor, wherein the base plate adaptor comprises a male thread portion capable of engaging with the female threaded portion of the main frame portion, and wherein a base ring of the base plate adaptor is capable of engaging with a 2 inch diameter sausage and/or cartridge barrel dispensing applicator gun and the applicator gun's front cap.
